(19) United States
(12) Patent Application Publication
(10) Pub. No.: US 2026/0070037 A1
(43) Pub. Date: Mar. 12, 2026

(54) WATER-RESPONSIVE FILM AND METHODS OF PRODUCING THE SAME

(71) Applicant: Kimberly-Clark Worldwide, Inc., Nennah, WI (US)

(72) Inventors: Richmond R. Cohen, Appleton, WI (US); Ingrid C. Hoeger Vivas, Chamblee, GA (US); Uyen T. Lam, Menasha, WI (US); Wing-Chak Ng, Roswell, GA (US); Peiguang Zhou, Suwanee, GA (US)

(73) Assignee: Kimberly-Clark Worldwide, Inc., Nennah, WI (US)

(21) Appl. No.: 18/998,787

(22) PCT Filed: Jul. 13, 2023
(86) PCT No.: PCT/US2023/027683

§ 371 Date: Jan. 27, 2025

Related U.S. Application Data
(60) Provisional application No. 63/400,642, filed on Aug. 24, 2022.

(51) Int. Cl. B01J 20/26; B01J 20/28; B01J 20/30

(52) U.S. Cl. CPC B01J 20/262; B01J 20/28016; B01J 20/28033; B01J 20/3007; B01J 20/3014; B01J 2220/68

(57) ABSTRACT

The present disclosure relates to a film including a substantially crystalline water-dispersible polymer and an aromatic thermoplastic polyurethane polymer. The film has a crystallinity of at least 25%. The film expands when contacted by water. The film may include one or more apertures that can open/close in response to water. The film expands when in contact with water, but retracts as it dries, allowing for multiple insults to trigger the expansion and retraction properties of the film.

### CROSS-REFERENCE TO RELATED APPLICATION

This application claims the benefit of and priority to U.S. Provisional Patent Application No. 63/400,642, filed Aug. 24, 2022, which is hereby incorporated by reference in its entirety for all intents and purposes.

### FIELD

The present disclosure generally relates to an expandable film and methods of making an expandable film. In particular, the present disclosure relates to a water-responsive film that expands when in contact with water.

### BACKGROUND

Absorbent articles such as diapers, incontinence garments, sanitary napkins, and menstrual pads, are designed to absorb and retain liquid and other discharges from the human body to prevent soiling of the body and clothing. Absorbent articles should provide adequate leakage protection for healthy, dry skin. To prevent leakage, the absorbent article should provide rapid passage of fluid (e.g., urine or menses) into the absorbent structure of the absorbent article and retain the fluid therein. If the fluid is not adequately retained within the absorbent structure of the absorbent article, pressure applied to the absorbent article may cause the fluid to travel from the interior of the absorbent article through a surface of the absorbent article. This can cause direct contact between fluids and a user's skin, which can result in overhydration of the skin, rendering it susceptible to irritation and infection.

To provide rapid intake of fluid, the materials comprising the absorbent structure of the absorbent article need to have sufficient permeability and wettability to facilitate intake of the fluid. Although these properties of absorbent articles provide for rapid intake of fluid, the same properties also allow for easy flowback, i.e., passage of fluid out of the absorbent article and onto the user's skin when pressure is applied to the absorbent article. As a result, there is a correlation between the rate of fluid intake and the rate and volume of flowback in conventional absorbent articles, giving rise to a phenomenon known as “easy in, easy out.” Accordingly, absorbent articles that are capable of rapid intake of fluid often have greater flowback of fluid, which can potentially lead to unwanted hydration of the skin. Conversely, absorbent articles that exhibit limited flowback of fluid tend to have slow fluid intake and more leakage.

There remains a need for an absorbent article that can adequately reduce the incidence of leakage of fluid from the absorbent article while keeping the skin sufficiently dry.

### SUMMARY

Covered embodiments of the present disclosure are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings and each claim.

In some embodiments, the present disclosure provides a water-responsive film comprising a water-soluble polymer and an aromatic thermoplastic polyurethane (TPU), wherein the film has a degree of crystallinity of at least 25%. In some embodiments, the water-soluble polymer comprises polyethylene oxide, hydroxypropyl cellulose, polyvinyl alcohol, polyvinyl pyrrolidone, polyvinyl pyridine, gelatinized starch, nylon copolymers, polyacrylic acid, or combinations thereof. In some embodiments, the water-soluble polymer comprises polyethylene oxide. In some embodiments, the polyethylene oxide comprises a molecular weight ranging from 50,000 g/mol to 500,000 g/mol. In some embodiments, aromatic TPU comprises a polyester-based TPU. In some embodiments, the film has a degree of crystallinity from 25% to 60%. In some embodiments, the film comprises the water-soluble polymer in an amount from 10 wt. % to 90 wt. %, based on the total weight of the film. In some embodiments, the film comprises the aromatic TPU in an amount from 10 wt. % to 90 wt. %, based on the total weight of the film. In some embodiments, a weight ratio of water-soluble polymer to the aromatic TPU is at least 1:1. In some embodiments, the film comprises the water-soluble polymer in an amount from 30 wt. % to 70 wt. %, based on the total weight of the film, TPU in an amount from 30 wt. % to 70 wt. %, based on the total weight of the film, and a ratio of water-soluble polymer to aromatic TPU is at least 1.5:1. In some embodiments, the film comprises one or more additives comprising surfactants, absorbents, antibiotics, or skin benefit agents. In some embodiments, the additive comprises a superabsorbent. In some embodiments, the film is cut or scored to include one or more apertures. In some embodiments, the film comprises a tensile strength from 10 to 50 MPa and a tensile modulus of from 1 to 5 MPa.

In some embodiments, the present disclosure provides a water-responsive film comprising: 30 wt. % to 70 wt. % of a water-soluble polymer, based on the total weight of the film, wherein the water-soluble polymer has a degree of crystallinity greater than 50%; 30 wt. % to 60 wt. % of an aromatic thermoplastic polyurethane, based on the total weight of the film; wherein the film has a degree of crystallinity from 25% to 60%.

In some embodiments, the present disclosure provides a method of producing a water-responsive expandable film, the method comprising: melt blending a composition comprising a water-soluble polymer and an aromatic TPU; and extruding the composition to produce a film. In some embodiments, the film comprises the water-soluble polymer in an amount from 30 wt. % to 70 wt. %, based on the total weight of the film, and the film comprises the aromatic TPU in an amount from 30 wt. % to 60 wt. %, based on the total weight of the film. In some embodiments, a ratio of the water-soluble polymer to the aromatic TPU in the composition is from 1:1 to 4:1. In some embodiments, the water-soluble polymer comprises polyethylene oxide, hydroxypropyl cellulose, polyvinyl alcohol, polyvinyl pyrrolidone, polyvinyl pyridine, gelatinized starch, nylon copolymers, polyacrylic acid, or combinations thereof, and the aromatic TPU comprises a polyester-based TPU. In some embodiments, the method further comprises cutting a pattern into the expandable film. In some embodiments, the method further comprises bonding the film to a base layer.

Further aspects, objects, and advantages will become apparent upon consideration of the detailed description.

### BRIEF DESCRIPTION OF THE DRAWINGS

FIG. 1 is a schematic of the microstructure of an expandable film in a contracted state and an expanded state, according to some embodiments of the present invention.

FIG. 2 is an illustration of an expandable film including an aperture as it transitions between a contracted state and an expanded state, according to some embodiments of the present invention.

FIG. 3 is a schematic of a system for producing an expandable film using a single-screw extruder, according to some embodiments of the present invention.

FIG. 4 is a schematic of a system for producing an expandable film using a twin-screw extruder, according to some embodiments of the present invention.

FIG. 5 is a schematic of a system for producing an expandable film by compounding and extruding a polymer blend, according to some embodiments of the present invention.

FIG. 6 is a flowchart of a method for producing an expandable film, according to some embodiments of the present invention.

FIG. 7A is a schematic of the shrinkage properties of a film including polyethylene oxide and thermoplastic polyolefin, and FIG. 7B is a schematic of the expansion properties of a film including polyethylene oxide and a thermoplastic polyurethane polymer, according to some embodiments of the present invention.

### DETAILED DESCRIPTION

### Introduction

The present disclosure relates to a water-responsive expandable film that permits rapid intake of fluid and limits flowback of the fluid. The water-responsive expandable film described herein includes a water-soluble polymer and an elastomeric thermoplastic polyurethane (TPU). In particular, the water-responsive expandable film includes a blend of two polymers: (1) a water-soluble polymer with a substantially crystalline morphology; and (2) an aromatic TPU. The film is elastic and water sensitive such that the film expands when in contact with fluids (e.g., urine, menses, or other bodily fluid). When unexpanded, the film allows rapid passage of a fluid through the film, and optionally into another material (e.g., an absorbent structure of an absorbent article). But as fluid flows through the film, the film also absorbs some of the fluid, and the film expands. In embodiments of the film including one or more apertures, sufficient expansion closes the apertures that initially facilitated rapid passage of the fluid. The closed apertures block further fluid from flowing through the film, both in the original flow direction and as flowback. Upon drying of the film, i.e., desorption of the fluid, the film contracts and can be used again. The dual attributes of elasticity and water-responsiveness are achieved by blending a synergistic combination of a water-soluble polymer and an aromatic TPU to produce a film having a crystallinity of at least 25%. It was found that the combination of an aromatic TPU having a suitable strength and tensile modulus with a water-soluble polymer having a suitable crystallinity produces a film that expands after contact with a fluid, followed by contraction of the film towards its original dimensions upon drying or desorption.

Conventional absorbent materials require a trade-off between rapid intake of fluid and retention of fluid To provide rapid intake of fluid, the materials comprising the absorbent structure of the absorbent article need to have sufficient permeability and wettability to facilitate intake of the incoming fluid. Unfortunately, these properties also tend to provide for easy passage of fluid out of the absorbent article and onto the user's skin. Therefore, known materials either rapidly intake fluid with poor retention of the fluid due to flowback, or they intake fluid slowly but retain it well.

The water-responsive expandable film described herein avoids the conventional correlation between rate of fluid intake and volume of flowback, and facilitates rapid intake of fluid into an absorbent article with limited flowback of fluid. That benefit arises from the film's ability to expand when in contact with fluid. As a first volume of fluid passes through the film into the absorbent article, the film expands and blocks the flow of additional fluid through the film, including flowback of the fluid that has already entered the absorbent article. In some embodiments, the film may be scored or cut to include a pattern. For example, the film may be laser-cut or stamped to provide one or more apertures having various geometries (e.g., circle, star-shaped, rectangular, square). In this way, the film can be utilized as a water-responsive one-way valve. The apertures in the film can be open in a first state and closed in a second state. The first state can be representative of a dry state of the film having the original dimensions of the film. The second state can be representative of the film after contact with water. As discussed above, due to the polymer chemistry, the film can expand from the first state to second state after contact with a fluid, and the expansion can cause the apertures to close. After the fluid is dried or desorbed, the film can contract to its original dimensions (or substantially the original dimensions) to open the apertures and return to the first state.

Beneficially, the water-responsive expandable film allows for rapid passage of fluid through the film and into an article (e.g., an absorbent article) and prevents fluid from flowing back out of the absorbent article. Due to the water-responsive expansion and contraction properties of the film, the mechanism to transition the apertures from an open first state to a closed second state does not require any action or input other than the fluid itself, i.e., the valve automatically opens or closes to allow or prevent fluid passage. The aperture thus functions as a valve, opening and closing to allow or prevent fluid passage. The state of the valve is determined by the amount of fluid absorbed by the film. In this way, the valve can alternate between the first state (e.g., contracted dimensions, open apertures) and a second state (expanded dimensions, closed apertures) for rapid passage of fluid into an absorbent article in the first state and retention of the fluid by preventing flowback in the second state. The ability of the film to expand when contacted by fluids and to shrink toward its original dimensions when dried enables the film to close and open the aperture/valve responsively and repeatedly, which differentiates it from known films, which only shrink when contacted by water.

### Definitions and Descriptions

The terms “invention,” “the invention,” “this invention,” and “the present invention” used herein are intended to refer broadly to all of the subject matter of this patent application and the claims below. Statements containing these terms should be understood not to limit the subject matter described herein or to limit the meaning or scope of the patent claims below.

As used herein, the meaning of “a,” “an,” or “the” includes singular and plural references unless the context clearly dictates otherwise.

As used herein, the terms “machine direction” or “MD” generally refers to the direction in which a material is produced. The term “cross-machine direction” or “CD” refers to the direction perpendicular to the machine direction. Dimensions measured in the cross-machine direction are referred to as “width” dimension, while dimensions measured in the machine direction are referred to as “length” dimensions.

As used herein, the term “bonded” refers herein to the joining, adhering, connecting, attaching, or the like, of two elements. Two elements will be considered bonded together when they are joined, adhered, connected, attached, or the like, directly to one another or indirectly to one another, such as when each is directly bonded to intermediate elements. The bonding of one element to another can occur via continuous or intermittent bonds.

As used herein, the term “liquid impermeable” refers to a layer or multi-layer laminate in which liquid body exudates, such as urine, will not pass through the layer or laminate, under ordinary use conditions.

As used herein, the term “liquid permeable” refers to any material that is not liquid impermeable.

As used herein, the term “superabsorbent” refers herein to a water-swellable, water-insoluble organic or inorganic material capable, under the most favorable conditions, of absorbing at least about 15 times its weight and, In some embodiments, at least about 30 times its weight, in an aqueous solution containing 0.9 weight percent sodium chloride. The superabsorbent materials can be natural, synthetic, and modified natural polymers and materials. In addition, the superabsorbent materials can be inorganic materials, such as silica gels, or organic compounds, such as cross-linked polymers.

As used herein, the term “thermoplastic” refers herein to a material which softens and which can be shaped when exposed to heat and which substantially returns to a non-softened condition when cooled.

As used herein, the terms “elastomeric” and “elastic” and refer to a material that, upon application of a stretching force, is stretchable in at least one direction (such as the CD direction), and which upon release of the stretching force, contracts/returns to approximately its original dimension. For example, a stretched material may have a stretched length that is at least 50% greater than its relaxed unstretched length, and will recover to within at least 50% of its stretched length upon release of the stretching force. A hypothetical example would be a one (1) inch sample of a material that is stretchable to at least 1.50 inches and which, upon release of the stretching force, will recover to a length of at least 1.25 inches. Desirably, the material contracts or recovers at least 50%, and even more desirably, at least 80% of the stretched length.

As used herein the terms “extensible” or “extensibility” generally refer to a material that stretches or extends in the direction of an applied force by at least about 50% of its relaxed length or width. An extensible material does not necessarily have recovery properties. For example, an elastomeric material is an extensible material having recovery properties. A film may be extensible, but not have recovery properties, and thus, be an extensible, non-elastic material.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., 5.5 to 10.

### Film and Film Microstructure

In some embodiments, the water-responsive expandable film includes a water-soluble polymer and an aromatic thermoplastic polyurethane (TPU). The specific combination of the polymers, the morphology of the polymers, and the amounts of the polymers in the film harness the elastic energy of the film, allowing it to expand when in contact with water (e.g., a bodily fluid). For example, the polymers can produce a film having sufficient crystallinity such that the film can expand when in contact with a fluid and subsequently retract to its original state. In this respect, the aromatic TPU is utilized as an elastomeric material that entangles the water-soluble polymer to provide for expansion of the film. The water-soluble polymer contributes to the crystallinity of the film such that when the film dries, the water-soluble polymer recrystallizes and retracts the film to its original dimensions. It was surprisingly and unexpectedly found that the combination of polymers described herein influences the ability and extent of water-responsive expansion and contraction.

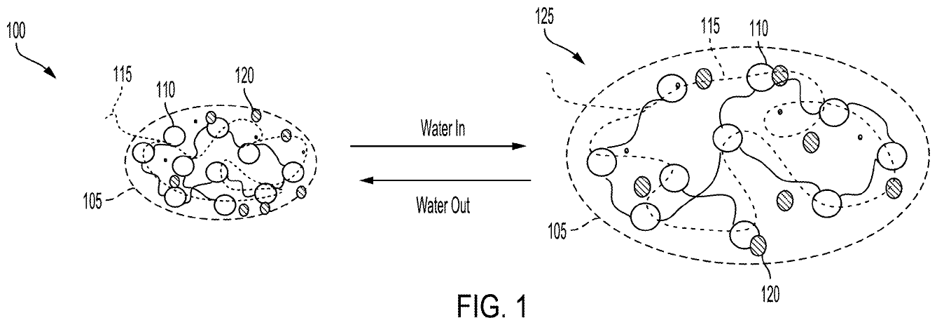

FIG. 1 illustrates the microstructure of a water-responsive expandable film 105 as it reversibly transitions between a contracted state 100 and an expanded state 125 according to some embodiments of the present invention. As shown in FIG. 1, the film 105 includes a water-soluble polymer 110, an aromatic TPU 115, and a superabsorbent powder 120. The water-soluble polymer 110 can be polyethylene oxide, but alternatively, other water-soluble polymers could be used provided they have sufficient crystallinity. Polyethylene oxide (“PEO”) generally has a high degree of crystallinity (e.g., greater than 50%). The water-soluble polymer 110 is represented by the open circles and the aromatic TPU 115 is shown as dashed lines partially entangling the water-soluble polymer 110. The filled circles represent the superabsorbent powder 120, an optional ingredient in embodiments of the film.

In the contracted state 100, the water-soluble polymer 110 is partially entangled with the aromatic TPU 115. The aromatic TPU 115 is a block copolymer including hard segments and soft segments. In some embodiments, the soft segments can be polyesters or polyethers, and the hard segments (e.g., urethane linkages) can be aromatic or aliphatic. It was found that the chemistry of the thermoplastic polyurethane controls whether the film is capable of expansion upon contact with fluid. Without wishing to be bound by theory, it is believed that when the thermoplastic polyurethane chains are entangled with the water-soluble polymer, the aromatic segments of the thermoplastic polyurethane chains (which are hydrophilic) interact more extensively with the water-soluble polymer than aliphatic segments would.

As shown in FIG. 1, the film 105 transitions from a contracted state 100 to an expanded state 125 with absorption of fluid (e.g., water, blood, sweat, etc.). The film 105 transitions from the expanded state 125 to the contracted state 100 with desorption of water. When the film 105 is contacted by water, the crystalline portions of the water-soluble polymer 110 begin to transition to a more amorphous state, and the polymer swells. The chemical attraction of the water-soluble polymer to the TPU, however, prevents the water-soluble polymer from fully dissolving, and instead the film swells. The change in morphology of the water-soluble polymer 110 effectively releases the elastic energy of the aromatic TPU 115. Because of the entanglements of the aromatic TPU 115 chains with the water-soluble polymer 110 chains, the elastic expansion of the aromatic TPU 115 grows as the water-soluble polymer 110 swells, and the film expands.

For comparison, a more hydrophobic aliphatic thermoplastic polyurethane has less chemical compatibility with water-soluble polymers, resulting in significantly fewer physical interactions (e.g., chain entanglements) with the thermoplastic polyurethane. Thus, when the water-soluble polymer absorbs water and its crystalline morphology transitions to a more amorphous state, the polymer swells and eventually dissolves, but that change has little effect on the aliphatic TPU, and there is no film expansion. In fact, in many instances the film will shrink.

The polymers are tailored to provide a combination of elasticity and rigidity. For example, to give the film elastomeric properties for expansion and recovery, the water-soluble polymer and aromatic TPU are selected to produce a film having a crystallinity of at least 25%, e.g., at least 30%, at least 35%, at least 40%, at least 45%, at least 50%, or at least 55%. In some embodiments, the film may have a crystallinity from 25% to 60%, e.g., from 30% to 60%, from 30% to 55%, from 35% to 55%, from 35% to 50%, from 40% to 60%, from 45% to 60%, from 40% to 50%, or anywhere between these ranges. The water-soluble polymer mainly contributes to the crystalline nature of the film.

In some embodiments, the water-responsive expandable film expands as it stays in contact with fluid until eventually the growth of the film reaches a maximum. After this time, continued contact with fluid results in the film beginning to contract. Without wishing to be bound by theory, it is believed that once a certain amount of water is absorbed, the water-soluble polymer dissolves, decoupling of chain entanglements occurs, and the expanded film shrinks from dissolution. When the film is no longer in contact with the fluid, the remaining water-soluble polymer recrystallizes with the TPU chains, and the film retracts toward its original dimensions. The crystalline nature of the water-soluble polymer harnesses the elastic energy of the elastomer once again, and the film may expand if exposed to fluid a second time.

### Thermoplastic Polyurethane

The film may include one or more TPU polymers. In some embodiments, the TPU comprises an aromatic TPU. The aromatic TPU serves as an elastomeric material to allow the film to expand. The combination of the aromatic TPU and a substantially crystalline water-soluble polymer in the film leads to the surprising and unexpected result of film expansion after contact with water, followed by contraction of the film towards its original dimensions upon drying or desorption. The ability of the film to expand when contacted by water and to shrink toward its original dimensions enables the film to close and open a valve (e.g., an aperture) responsively and repeatedly compared to films of the prior art, which only have the capability to shrink when contacted by water.

In some embodiments, the aromatic TPU polymer is hydrophilic. The TPU polymer may be present in the film in an amount from 10 wt. % to 90 wt. %, based on the total weight of the film, e.g., from 15 wt. % to 85 wt. %, from 20 wt. % to 80 wt. %, from 25 wt. % to 75 wt. %, from 30 wt. % to 70 wt. %, from 30 wt. % to 65 wt. %, from 30 wt. % to 70 wt. %, from 35 wt. % to 65 wt. %, or from 40 wt. % to 60 wt. %. In some embodiments, the film includes at least 10 wt. % TPU polymer, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, or at least 70 wt. %. In some embodiments, the film includes from 40 wt. % to 60 wt. % TPU.

The film includes the aforementioned amounts of TPU to ensure that the elastic properties of the film allow for expansion. It was found that that the chemistry of the TPU contributes to the expansion properties of the film when in contact with water. Without being bound by theory, it is believed that when the TPU chains are entangled with a water-soluble polymer (e.g., polyethylene oxide), the hydrophilic aromatic TPU chains interact with the water-soluble polymer more extensively compared to a hydrophobic aliphatic TPU chains. As a result, when in contact with water, the crystalline regions of the water-soluble polymer begin to transition to a more amorphous state, which causes the polymer to swell. The change in morphology of the water-soluble polymer during swelling effectively releases the elastic energy of the aromatic TPU.

TPUs are generally synthesized from a polyol, organic diisocyanate, and optionally a chain extender. A polyol is generally any high molecular weight product having an active hydrogen component that may be reacted and includes materials having an average of about two or more hydroxyl groups per molecule. Long-chain polyols may be used that include higher polymeric polyols, such as polyester polyols and polyether polyols and polyols that have an active hydrogen component, such as polyhydroxy polyester amides, hydroxyl containing polycaprolactones, hydroxy-containing acrylic interpolymers, hydroxy-containing epoxies, and hydrophobic polyalkylene ether polyols. Typically, the polyol is substantially linear and has two to three hydroxyl groups, and a number average molecular weight of from 450 to 10,000, e.g., 450 to about 6000, or from 600 to 4500. Short-chain diols provide a harder, more crystalline polymer segment, and long-chain diols provide a softer, more amorphous polymer segment.

Suitable polyether diols may be produced by, for example, reacting one or more alkylene oxides having 2 to 4 carbon atoms in the alkylene residue with a starter molecule that contains two or more active hydrogen atoms in bound form. Exemplary alkylene oxides include ethylene oxide, 1,2-propylene oxide, epichlorohydrin and 1,2-butylene oxide and 2,3-butylene oxide. Exemplary starter molecules include water; aminoalcohols, such as N-alkyl-diethanolamines (e.g., N-methyl-diethanolamine); and diols, such as ethylene glycol, 1,3-propylene glycol, 1,4-butanediol and 1,6-hexanediol. In some embodiments, suitable polyester diols include ethanediol polyadipates, 1,4-butanediol polyadipates, ethanediol/1,4-butanediol polyadipates, 1,6-hexanedianeopentyl glycol polyadipates, 1,6-hexanediol/1,4-butanediol polyadipates and polycaproplactones.

The organic diisocyanates may include aromatic diisocyanates, such as 2,4- or 2,6-toluene diisocyanate, 4,4′-diphenylmethane diisocyanate, 2,4′-diphenylmethane diisocyanate, 2,2′-diphenylmethane diisocyanate, naphthylene-1,5-diisocyanate, xylylene diisocyanate, methylene diphenyl isocyanate (“MDI”), hexamethylene diisocyanate (“HMDI”), mixtures thereof, etc.

The chain extenders typically have a number average molecular weight of from about 60 to 400 and includes amino, thiol, carboxyl, and/or hydroxyl functional groups. In some embodiments, the chain extenders include two to three hydroxyl groups. As set forth above, one or more compounds selected from the aliphatic diols that contain from 2 to 14 carbon atoms may be used as the chain extender. Such compounds include, for example, ethanediol, 1,2-propanediol, 1,3-propanediol, 1,4-butanediol, 2,3-butanediol, 1,5-pentanediol, 1,6-hexanediol, diethylene glycol, dipropylene glycol, 1,4-cyclohexanediol, 1,4-dimethanolcyclohexane and neopentyl glycol. Diesters of terephthalic acid with glycols having 2 to 4 carbon atoms may also be employed. Some examples of such compounds include terephthalic acid bis-ethylene glycol and terephthalic acid bis-1,4-butanediol, hydroxyalkylene ethers of hydroquinone (e.g., 1-4-di(β-hydroxyethyl) hydroquinone), ethoxylated bisphenols (e.g., 1,4-di(β-hydroxyethyl)bisphenol A), (cyclo) aliphatic diamines (e.g., isophoronediamine, ethylenediamine, 1,2-propylenediamine, 1,3-propylenediamine, N-methyl-1,3-propylenediamine, and N,N′-dimethylethylene-diamine), and aromatic diamines (e.g., 2,4-toluenediamine, 2,6-toluenediamine, 3,5-diethyl-2,4-toluenediamine and 3,5-diethyl-2,6-toluenediamine, and primary mono-, di-, tri- or tetraalkyl-substituted 4,4′-diaminodiphenylmethanes).

In addition to those noted above, other components may also be employed to form the TPU. Catalysts, for instance, may be employed to facilitate formation of the polyurethane. Suitable catalysts include, for instance, tertiary amines, such as triethylamine, dimethylcyclohexyl-amine, N-methylmorpholine, N,N′-dimethylpiperazine, 2-(dimethylaminoethoxy)-ethanol, diazabicyclo[2.2.2]octane, etc. as well as metal compounds, such as titanic acid esters, tin diacetate, tin dioctoate, tin dilaurate or the dialkyltin salts of aliphatic carboxylic acids such as dibutyltin diacetate or dibutyltin dilaurate or other similar compounds. Still other suitable additives that may be employed include light stabilizers (e.g., hindered amines), chain terminators, slip agents and mold release agents (e.g., fatty acid esters, the metal soaps thereof, fatty acid amides, fatty acid ester amides and silicone compounds), plasticizers, antiblocking agents, inhibitors, stabilizers against hydrolysis, heat and discoloration, dyes, pigments, inorganic and/or organic fillers, fungistatically and bacteriostatically active substances, fillers, etc.

In some embodiments, the TPU has a melting point of from 75° C. to 250° C., for example, from 100° C. to 240° C. or from 120° C. to 220° C. The glass transition temperature (“T_{g}”) of the TPU may be relatively low, for example, from −150° C. to 0° C., e.g., from −100° C. to −10° C., and from −85° C. to −20° C. The melting temperature and glass transition temperature may be determined using differential scanning calorimetry (“DSC”) in accordance with ASTM D-3417.

Examples of aromatic TPUs used in the films described herein include those available under the designation ESTANE™, PEARLSTICK™, and PEARLBOND™ from The Lubrizol Co. and under the designation WANTHANER from Wanhua Chemical Group Co., Ltd. For example, ESTANE™ 58238, ESTANE™ EZ-44-61 EXP and WANTHANER WHT-F170 are aromatic polyester-based polyurethanes that can be used in the films described herein. For example, ESTANE™ MVT 75AT3 is an aromatic polyether-based polyurethane that can be used in the films described herein.

Other physical properties of the TPU may influence the ability and extent of water-responsive expansion of the films described herein. Table 1 provides several grades of TPUs and their chemical and physical properties. The tensile strength and tensile modulus of the TPU are important parameters to support robust expansion of the film. For example, an aromatic TPU having poor tensile strength and low molecular weight may not be able to support robust expansion of the film. On the other hand, if the tensile modulus is too high, the aromatic TPU may be too stiff for expansion and the TPUs may not have sufficient elasticity for expansion of the film.

In some embodiments, the tensile modulus of the TPU can range from 0.5 MPa to 8 MPa at an elongation of 100% as measured according to ASTM D-412 (2022), e.g., from 0.75 MPa to 7 MPa, from 0.9 MPa to 6 MPa, from 1 MPa to 5.5 MPa, from 1 MPa to 5 MPa, from 1.5 MPa to 4.5 MPa, or from 2 MPa to 4 MPa. In some embodiments, the tensile modulus of the TPU can range from 1 MPa to 5 MPa at an elongation of 100% as measured according to ASTM D-412 (2022).

In some embodiments, the tensile strength of the TPU can range from 5 MPa to 100 MPa, e.g., from 10 MPa to 80 MPa, from 15 MPa to 60 MPa, from 20 MPa to 50 MPa, from 25 MPa to 50 MPa, from 30 MPa to 60 MPa, or from 30 MPa to 50 MPa. In some embodiments, the tensile strength of the TPU can range from 20 MPa to 50 MPa.

In some embodiments, the shore hardness value the TPU can range from 50 to 90 as measured by ASTM D-2240 (2022), e.g., from 55 MPa to 85 MPa, from 60 MPa to 80 MPa, from 60 MPa to 75 MPa, from 65 MPa to 80 MPa, or from 70 MPa to 80 MPa. In some embodiments, the shore hardness value the TPU can range from 60 to 80.

TPU-1 denotes an aromatic polyether-based thermoplastic polymer. The product is available under the name ESTANE™ MVT 75AT3 (Lubrizol). The properties of the thermoplastic may be found below in Table 1.

TPU-2 denotes an aromatic polyester-based thermoplastic polymer. The product is available under the name WANTHANER WHT-F170 (Wanhua). The properties of the thermoplastic may be found below in Table 1.

TPU-3 denotes an aromatic polyester-based thermoplastic polymer. The product is available under the name ESTANE™ 58238 (Lubrizol). The properties of the thermoplastic may be found below in Table 1.

TPU-4 denotes an aromatic polyester-based thermoplastic polymer. The product is available under the name ESTANE™ EZ-44-61 EXP (Pearlbond 405 EXP) (Lubrizol). The properties of the thermoplastic may be found below in Table 1.

TPU-5 denotes an aromatic polyester-based thermoplastic polymer. The product is available under the name PEARLSTICK® 5702 F3 (Lubrizol). The properties of the thermoplastic may be found below in Table 1.

TPU-6 denotes an aromatic polyester-based thermoplastic polymer. The product is available under the name PEARLSTICK® 302 EXP (Lubrizol). The properties of the thermoplastic may be found below in Table 1.

TPU-7 denotes an aromatic polyester-based thermoplastic polymer. The product is available under the name PEARLSTICK® 305 EXP (Lubrizol). The properties of the thermoplastic may be found below in Table 1.

TPU-8 denotes an aliphatic polyether-based thermoplastic polymer. As used herein, the product may be used as a comparative example for comparing Aromatic based thermoplastic polymers to aliphatic thermoplastic polymers. The product is available under the name ESTANE™ AG 8451 (Lubrizol). The properties of the thermoplastic may be found below in Table 1.

TPU-9 denotes an aliphatic polyether-based thermoplastic polymer. As used herein, the product may be used as a comparative example for comparing Aromatic based thermoplastic polymers to aliphatic thermoplastic polymers. The product is available under the name ELASTOLLAN® LL1275A10 (BASF). The properties of the thermoplastic may be found below in Table 1.

TPU-10 denotes an aliphatic polyester-based thermoplastic polymer. As used herein, the product may be used as a comparative example for comparing Aromatic based thermoplastic polymers to aliphatic thermoplastic polymers. The product is available under the name ESTANE™ CLC93A-V (Lubrizol). The properties of the thermoplastic may be found below in Table 1.

TABLE 1

| | | | | | Tensile | | Tensile | | | |
|---|---|---|---|---|---|---|---|---|---|---|
| | | | | | stress @ | | stress @ | | | |
| | | | Tensile | | 100% | | 300% | | Ultimate | |
| Trade | Type of | Hardness | Strength | | elongation- | | elongation- | | elongation | Size |
| Name | Polymer | (Shore A) | (MPa) | | psi (MPa) | | psi (MPa) | | (%) | change |
| TPU-1 | Aromatic | 75 | 5000 | (34.5) | 600 | (4.1) | 900 | (6.2) | 700 | Expand |
| | Polyether | | | | | | | | | |
| TPU-2 | Aromatic | 72 | 3626 | (25) | 363 | (2.5) | 870 | (6) | 600 | Expand |
| | Polyester | | | | | | | | | |
| TPU-3 | Aromatic | 75 | 7000 | (48.3) | 650 | (4.5) | 1800 | (12.4) | 680 | Expand |
| | Polyester | | | | | | | | | |
| TPU-4 | Aromatic | 65 | 2500 | (17.2) | 380 | (2.62) | 540 | (3.7) | 1100 | Expand |
| | Polyester | | | | | | | | | |
| TPU-5 | Aromatic | 65 | 5366 | (37) | 290 | (2) | 725 | (5) | 590 | Expand |
| | Polyester | | | | | | | | | |
| TPU-6 | Aromatic | 55 | 2031 | (14) | 189 | (1.3) | 261 | (1.8) | 900 | Expand |
| | polyester- | | | | | | | | | |
| TPU-7 | Aromatic | 64 | 682 | (4.7) | 348 | (2.4) | 580 | (4) | 450 | Expand |
| | polyester- | | | | | | | | | |
| TPU-8 | Aliphatic | N/A | 7000 | (48.3) | 500 | (3.45) | 2000 | (13.8) | 475 | Shrink |
| | Polyether | | | | | | | | | |
| TPU-9 | Aliphatic | 70 | 5076 | (35) | 363 | (2.5) | 870 | (6) | 550 | Shrink |
| | Polyether | | | | | | | | | |

| | | | | | | | | | |
|---|---|---|---|---|---|---|---|---|---|
| TPU-10 | Aliphatic | 93 | 9000 | (62.1) | 1000 | (6.9) | N/A | 410 | Shrink |
| | Polyester | | | | | | | | |

Table 1 highlights the criticality of the chemistry of the TPU, which is evident by comparing the aliphatic and aromatic character of the TPU in the third column. Each of the TPUs in Table 1 were blended with a water-soluble polymer and extruded into a film to investigate the effect of the TPU on the properties of the film. Each of the films produced from an aromatic TPU expanded when in contact with water, whereas films produced from aliphatic TPU, both polyether based and polyester based, shrank when in contact with water. TPU-9, an aliphatic polyether-based TPU, had similar physical properties to TPU-1, an aromatic polyether-based TPU, and TPU-2, an aromatic polyester-based TPU. However, the film including the aliphatic polyether TPU-9 shrank, while the films including the aromatic polyether TPU-1 and the aromatic polyester TPU-2 both expanded.

TPU-8, an aliphatic polyether-based TPU, had similar physical properties to TPU-3, an aromatic polyester-based TPU. Once again, the films produced from the aromatic polyether-based TPU expanded while the films including an aliphatic polyether-based TPU shrank. All the aromatic TPUs are examples of elastomers that may be used in the water-responsive expandable film described herein. It is contemplated that other aromatic TPUs with similar physical properties to those in Table 1 represent additional exemplary elastomeric components that can be used in the films described herein.

### Water-Soluble Polymer

The film also includes one or more water-soluble polymers. The water-soluble polymer may be present in the film in an amount from 10 wt. % to 90 wt. %, based on the total weight of the film, e.g., from 15 wt. % to 85 wt. %, from 20 wt. % to 80 wt. %, from 25 wt. % to 75 wt. %, from 30 wt. % to 70 wt. %, from 30 wt. % to 65 wt. %, from 30 wt. % to 70 wt. %, from 35 wt. % to 65 wt. %, or from 40 wt. % to 60 wt. %. In some embodiments, the film includes at least 10 wt. % of water-soluble polymer, e.g., at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, or at least 70 wt. %. In some embodiments, the film includes water-soluble polymer in an amount from 40 wt. % to 60 wt. %, based on the total weight of the film.

In some embodiments, the water-soluble polymer has a substantially crystalline (e.g., degree of crystallinity of at least 50%) morphology. The expansion and contraction properties of the film are partially dependent on the morphology and molecular weight of the water-soluble polymer. For example, the crystalline morphology of the water-soluble polymer enables the water-soluble polymer to transition from the crystalline state to the amorphous state when in contact with water. When the film is no longer in contact with the fluid, the remaining water-soluble polymer recrystallizes with the TPU chains, and the film retracts toward its original dimensions after desorption or drying. The crystalline nature of the water-soluble polymer “locks” the elastic energy of the elastomer (e.g., TPU).

The water-soluble polymer contributes to the crystallinity of the film. In some embodiments, the water-soluble polymer comprises a crystallinity greater than 50%. For example, the water-soluble polymer comprises a crystallinity greater than 50%, greater than 55%, greater than 60%, greater than 65%, greater than 70%, greater than 75%, greater than 80%, greater than 85%, or greater than 90%. In some embodiments, the water-soluble polymer comprises a crystallinity from 50% to 95%, e.g., from 55% to 95%, from 60% to 95%, from 65% to 90%, from 70% to 90%, from 75% to 90%, or from 80% to 95%.

In some embodiments, the water-soluble polymers employed in the films described herein generally have a high molecular weight. For example, the water-soluble polymers may have a weight average molecular weight (Mw) greater than 25,000, greater than 50,000, greater than 75,000, greater than 100,000, greater than 125,000, greater than 150,000, greater than 175,000, greater than 200,000, greater than 225000, or greater than 250,000. In some embodiments, the water-soluble polymers has a weight average molecular weight (Mw) ranging from 25,000 to 500,000 grams per mole, e.g., from 50,000 to 475,000 grams per mole, from 75,000 to 450,000 grams per mole, from 80,000 to 400,000 grams per mole, from 90,000 to 350,000 grams per mole, from 100,000 to 300,000 grams per mole, from 100,000 to 250,000 grams per mole, from 100,000 to 200,000 grams per mole, or from 150,000 to 250,000 grams per mole. In some embodiments, the water-soluble polymer is polyethylene oxide. In some embodiments, the polyethylene oxide has a weight average molecular weight (Mw) greater than 25,000, greater than 50,000, greater than 75,000, greater than 100,000, greater than 125,000, greater than 150,000, greater than 175,000, greater than 200,000, greater than 225000, or greater than 250,000.

As described herein, the water-soluble polymer and aromatic TPU are specifically tailored to produce a film having a crystallinity from 25% to 60%. The water-soluble polymer mainly contributes to the crystalline nature of the film. In some embodiments, the water-soluble polymer may comprise polyethylene oxide, hydroxypropyl cellulose, polyvinyl alcohol, polyvinyl pyrrolidone, polyvinyl pyridine, gelatinized starch, nylon copolymers, polyacrylic acid, and mixtures thereof.

PEO-1 denotes a water-dispersible polyethylene oxide polymer. The product is available under the name POLYOX™ WSR N-80 and available from DuPont, Inc.

PEO-2 denotes a water-dispersible polyethylene oxide polymer. The product is available under the name POLYOX™ WSR N-10 and available from DuPont, Inc.

PVOH-1 denotes a water-dispersible polyvinyl alcohol polymer. The product is available under the name NICHIGO G-POLYMER™ OKS-8035 and available from Soarus, Inc.

In some embodiments, the water-soluble polymer can be polyethylene oxide (PEO). For example, a commercially available polyethylene oxide with high crystallinity is PEO-1. Table 2 provides the thermal analysis of films including PEO-1 and TPU-2, which is an aromatic TPU. The film including 100 wt. % polyethylene oxide exhibited a crystallinity of 77% measured by differential scanning calorimetry (DSC) thermal analysis. Each of the compositions including a blend of PEO-1 and TPU-2 exhibited sufficient crystallinity to expand when in contact with water. The films including 100 wt. % TPU did not exhibit any crystallinity based on the DSC analysis due to their amorphous morphology.

TABLE 2

| | Melting Point ° C. | Xc (%) | T_{g} (° C.) |
|---|---|---|---|
| 100% PEO | 65.6 | 77.0 | — |
| 80% PEO-1/20% | 63.0 | 61.0 | −44.5 |
| TPU-2 | | | |
| 70% PEO-1/30% | 61.9 | 56.0 | −45.5 |
| TPU-2 | | | |
| 60% PEO-1/40% | 60.9 | 47.8 | −46.3 |
| TPU-2 | | | |
| 100% TPU-2 | — | — | −45.7 |

In some embodiments, the water-soluble polymers can be homopolymers or interpolymers (e.g., copolymer, terpolymer, etc.), and can be nonionic, anionic, cationic, or amphoteric. In addition, the polymer may be of one type (i.e., homogeneous), or mixtures of different polymers may be used (i.e., heterogeneous). In one particular embodiment, the water-soluble polymer contains a repeating unit having a functional hydroxyl group, such as polyvinyl alcohol (“PVOH”), copolymers of polyvinyl alcohol (e.g., ethylene vinyl alcohol copolymers, methyl methacrylate vinyl alcohol copolymers, etc.). Vinyl alcohol polymers, for instance, have at least two or more vinyl alcohol units in the molecule and may be a homopolymer of vinyl alcohol, or a copolymer containing other monomer units. Vinyl alcohol homopolymers may be obtained by hydrolysis of a vinyl ester polymer, such as vinyl formate, vinyl acetate, vinyl propionate, etc. Vinyl alcohol copolymers may be obtained by hydrolysis of a copolymer of a vinyl ester with an olefin having 2 to 30 carbon atoms, such as ethylene, propylene, 1-butene, etc.; an unsaturated carboxylic acid having 3 to 30 carbon atoms, such as acrylic acid, methacrylic acid, crotonic acid, maleic acid, fumaric acid, etc., or an ester, salt, anhydride or amide thereof; an unsaturated nitrile having 3 to 30 carbon atoms, such as acrylonitrile, methacrylonitrile, etc.; a vinyl ether having 3 to 30 carbon atoms, such as methyl vinyl ether, ethyl vinyl ether, etc.; and so forth.

The degree of hydrolysis may be selected to optimize solubility, etc., of the water-soluble polymer. For example, the degree of hydrolysis may be from 60 mole % to 95 mole %, e.g., from 80 mole % to 90 mole % or from 85 mole % to 89 mole %. Examples of suitable partially hydrolyzed polyvinyl alcohol polymers are available under the designation CELVOL™ 203, 205, 502, 504, 508, 513, 518, 523, 530, or 540 from Celanese Corp. Other suitable partially hydrolyzed polyvinyl alcohol polymers are available under the designation ELVANOL™ 50-14, 50-26, 50-42, 51-03, 51-04, 51-05, 51-08, and 52-22 from DuPont.

The relative amount of the water-soluble polymer and TPU employed in the film may also be selected to help further optimize expansion and retraction properties of the film. In some embodiments, the weight ratio of the water-soluble polymer to the TPU is from 0.5:1 to 8:1, e.g., from 1:1 to 7:1, from 1.25:1 to 6:1, from 1.5:1 to 5:1, from 1.5:1 to 4:1, from 1.5:1 to 3:1, from 1.5:1 to 2.5:1, from 1:1 to 3:1, or from 1.25:1 to 2:1. The TPU may constitute from 10 wt. % to 90 wt. %, e.g., from 15 wt. % to 60 wt. % or from about 20 wt. % to about 50 wt. %, based on the total weight of the film. The water-soluble polymer may constitute from 10 wt. % to 90 wt. %, e.g., from 20 wt. % to 80 wt. % or from 40 wt. % to 70 wt. %, based on the total weight of the film.

### Additives

In some embodiments, the film may optionally include one or more additives. In some embodiments, the additives may include surfactants, absorbents, skin benefit agents, plasticizer, minerals, antibiotics, or any combination thereof. For example, the film may include superabsorbent polymers. The superabsorbent polymers are generally employed to increase the absorbent capacity of the film and expansion. In some embodiments, the superabsorbent polymers are present in the film in the form of small particles. Superabsorbent polymeric powders suitable for the film include, but are not limited to, a wide variety of anionic, cationic, and nonionic materials. Suitable polymers include polyacrylamides, polyvinyl alcohols, ethylene maleic anhydride copolymer, polyvinylethers, polyacrylic acids, polyvinylpyrrolidones, polyvinylmorpholines, polyamines, polyethyleneimines, polyquaternary ammoniums, natural based polysaccharide polymers such as carboxymethyl celluloses, carboxymethyl starches, hydroxypropyl celluloses, algins, alginates, carrageenans, acrylic grafted starches, acrylic grafted celluloses, chitin, chitosan, and synthetic polypeptides such as polyaspartic acid, polyglutamic acid, polyasparagins, polyglutamines, polylysines, and polyarginines, as well as the salts, copolymers, and mixtures of any of the foregoing polymers.

In addition to the components noted above, other additives may also be incorporated into the film, such as slip additives (e.g., fatty acid salts, fatty acid amides, etc.), compatibilizers (e.g., functionalized polyolefins), dispersion aids, melt stabilizers, processing stabilizers, heat stabilizers, light stabilizers, antioxidants, heat aging stabilizers, whitening agents, antiblocking agents, bonding agents, lubricants, fillers, etc.

In some embodiments, the film may include fillers. Fillers are particulates or other forms of material that may be added to the film polymer extrusion blend and that will not chemically interfere with the extruded film, but which may be uniformly dispersed throughout the film. Fillers may serve a variety of purposes, including enhancing film opacity and/or breathability (i.e., vapor-permeable and substantially liquid-impermeable). For instance, filled films may be made breathable by stretching, which causes the polymer to break away from the filler and create microporous passageways. Breathable microporous elastic films are described, for example, in U.S. Pat. Nos. 5,997,981; 6,015,764; and U.S. Pat. No. 6,111,163 to McCormack, et al.; U.S. Pat. No. 5,932,497 to Morman, et al.; U.S. Pat. No. 6,461,457 to Taylor, et al., all of which are incorporated by reference in their entireties for all intents and purposes. Further, hindered phenols are commonly used as an antioxidant in the production of films. Some suitable hindered phenols include those available from Ciba Specialty Chemicals under the trade name “Irganox®”, such as Irganox® 1076, 1010, or E 201. Moreover, bonding agents may also be added to the film to facilitate bonding of the film to additional materials (e.g., nonwoven webs). Examples of such bonding agents include hydrogenated hydrocarbon resins. Other suitable bonding agents are described in U.S. Pat. No. 4,789,699 to Kieffer et al. and U.S. Pat. No. 5,695,868 to McCormack, which are incorporated by reference in their entireties for all intents and purposes.

### Film Construction and Valve Design

In some embodiments, the film may be mono- or multi-layered. Multilayer films may be prepared by co-extrusion of the layers, extrusion coating, or by any conventional layering process. In some embodiments, the multilayer films may include at least one base layer and at least one skin layer. In some embodiments, the multilayer films may include a plurality of layers. For example, the multilayer film may be formed from a base layer and one or more skin layers, wherein the base layer is formed from a blend of the water-soluble polymer and TPU. In some embodiments, the skin layer(s) are also formed from the blend as described above. It should be understood, however, that other polymers may also be employed in the skin layer(s).

In some embodiments, the film described herein can include one or more apertures such that the film can function as a valve. The film can be attached to at least one substrate. For example, the film may be adhesively bonded to at least one base layer. The film is bound to at least one substrate (top and/or bottom) to control lateral expansion and closing of the apertures that function as a valve. This can be achieved by patterning an adhesive layer that leaves a specific unbound area adjacent to the one or more apertures of the film. The lateral expansion of the unbound film allows the apertures to close when contacted by water. The amount of expansion (e.g., lateral expansion) may be influenced by the composition of the film, the ratio of water-soluble polymer to TPU, and the amount of fluid contacting the film.

For example, the film described herein can be bonded or attached to at least one base layer to regulate the amount of water flowing to and from the base layer. In some embodiments, the base layer can be an absorbent structure of an absorbent article. The film may include one or more apertures that allows for fluid intake to the absorbent structure. Fluid that contacts the film can pass through the apertures to the absorbent structure. A portion of the fluid can be absorbed by the film. The fluid absorbed by the film causes the film to expand and close the apertures, thereby serving as a valve to the absorbent structure.

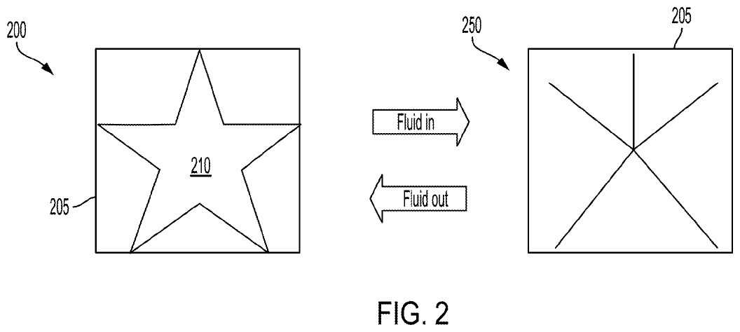

FIG. 2 shows an embodiment of the films described herein including an aperture for fluid flow through the film. FIG. 2 illustrates the film as it transitions between a contracted state 200 and an expanded state 250. The film 205 may be any of the films described herein. For example, the film 205 may comprise a water-soluble polymer that is substantially crystalline (e.g., greater than 50% crystallinity) and an aromatic TPU. The film 205 may include one or more apertures 210. In the embodiment shown in FIG. 2, the film 205 includes a star-shaped aperture 210. The film 205 can have a plurality of different shapes to provide a desired flow rate of fluid through the apertures. For example, the total area of the film 205 occupied by the aperture can be at least 25% e.g., at least 30%, at least 35%, at least 40%, at least 45%, at least 50%, or at least 55%. Films that include a larger area for the apertures can provide faster fluid intake.

As shown in FIG. 2, the film 205 may be in a contracted state 200 or an expanded state 250. In the contracted state 200, the film 205 is dry. The contracted state 200 represents an initial state of the film with the aperture 210 open. In the contracted state 200, the film 205 provides an opening, i.e., aperture 210, for fluid intake. As discussed herein, in the contracted state 200, the water-soluble polymer is entangled by the aromatic TPU and pulls the elastic aromatic TPU to a contracted state due to the crystalline morphology of the water-soluble polymer.

FIG. 2 also illustrates the film 205 in an expanded state 250 after it has absorbed water. In the expanded state 250, expansion of the film 205 closes the aperture 210, which prevents fluid flowback. When the film 205 absorbs fluid (e.g., water), the water-soluble polymer begins to transition from a crystalline state to an amorphous state. The change in morphology of the water-soluble polymer from the contracted state 200 to the expanded state 250 causes the film 205 to swell, effectively releasing the elastic energy of the aromatic TPU. In other words, the film expands as the water-soluble polymer swells because of the entanglements of the TPU chains with the hydrophilic water-soluble polymer chains. Thus, the film 205 absorbs water and the morphology of the water-soluble polymer transitions to the amorphous state for film expansion.

### Method of Producing Films

Any known technique may be used to form a film described herein, including blowing, casting, flat die extruding, etc. In some embodiments, the film may be formed by a blown process in which a gas (e.g., air) is used to expand a bubble of the extruded polymer blend through an annular die. The bubble is then collapsed and collected in flat film form. Processes for producing blown films are described, for instance, in U.S. Pat. No. 3,354,506 to Raley; U.S. Pat. No. 3,650,649 to Schippers; and U.S. Pat. No. 3,801,429 to Schrenk et al., as well as U.S. Patent Application Publication Nos. 2005/0245162 to McCormack, et al. and 2003/0068951 to Boggs, et al., all of which are incorporated by reference in their entireties for all intents and purposes. In another embodiment, the film is formed using a casting technique.

In some embodiments, the film can be formed by blending each of the components together using any of a variety of known techniques. In one embodiment, for example, the components may be supplied separately or in combination. For instance, the components may first be dry mixed together to form an essentially homogeneous mixture, and they may likewise be supplied either simultaneously or in sequence to a melt processing device (e.g., extruder) that uniformly blends the materials.

In some embodiments, the methods for producing the film may include batch and/or continuous melt processing techniques. For example, a mixer/kneader, Banbury mixer, Farrel continuous mixer, single-screw extruder, twin-screw extruder, roll mill, etc., may be utilized to blend and melt process the materials. Examples of suitable melt processing devices may include a co-rotating, twin-screw extruder (e.g., USALAB twin-screw extruder available from Thermo Electron Corporation of Stone, England, or an extruder available from Werner-Pfreiderer from Ramsey, N.J.). Such extruders may include feeding and venting ports and provide high intensity distributive and dispersive mixing. For example, the components may be fed to the same or different feeding ports of the twin-screw extruder and melt blended to form a substantially homogeneous melted mixture. If desired, other additives may also be injected into the polymer melt and/or separately fed into the extruder at a different point along its length.

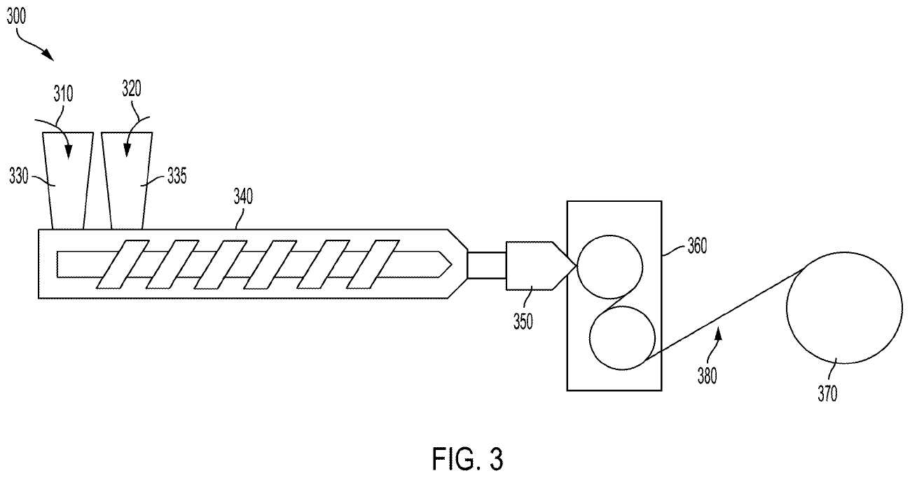

FIG. 3 illustrates one exemplary system for producing a film according to some embodiments of the invention. The raw materials (e.g., water-soluble polymer, TPU, superabsorbent polymer, optional additives, etc.) may be supplied to a melt blending device, either separately or as a blend. For example, the components can be separately supplied to a melt blending device where they are uniformly blended in a manner such as described above. For example, an extruder may be employed that includes one or more feeding and venting ports The system of FIG. 3 is a one-step process for producing a film using an extruder 340 (e.g., a single-screw extruder). In some embodiments, the water-soluble polymer 310 and TPU 320 can be flood fed into the feed ports (e.g., hopper) of extruder 340. The polymer melt from the extruder 340 can be processed in the film die 350 to produce the film 380.

The system 300 for producing the film 380 may include an extruder 340, a film die 350, a chill roller 360, and optionally a winder 370. In the embodiment shown in FIG. 3, the water-soluble polymer 310 is fed to a first feeding port 330 and the TPU 320 is fed to a second feeding port 335. In some embodiments, the TPU 320 may be first fed to a feeding port of an extruder 340 and melted. Thereafter, water-soluble polymer 310 and optional additives may be fed into the polymer melt. The materials are blended under high shear/pressure and heat to ensure sufficient mixing in the extruder 340.

The extruder 340 may be a single-screw extruder. Commercially available single-screw extruders suitable for producing the film include, for example, HAAKE™ Rheomex OS Single Screw Extruder from Thermo Fisher Scientific, Waltham, MA. In some embodiments, melt blending may occur at a temperature of from 50° C. to 300° C., e.g., from 75° C. to 250° C., from 100° C. to 225° C., from 120° C. to 215° C. or from 120° C. to 200° C. In some embodiments, the shear rate during melt blending may range from 100 seconds⁻¹ to 10,000 seconds⁻¹, e.g., from 500 seconds⁻¹ to 5000 seconds⁻¹ or from 800 seconds⁻¹ to 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

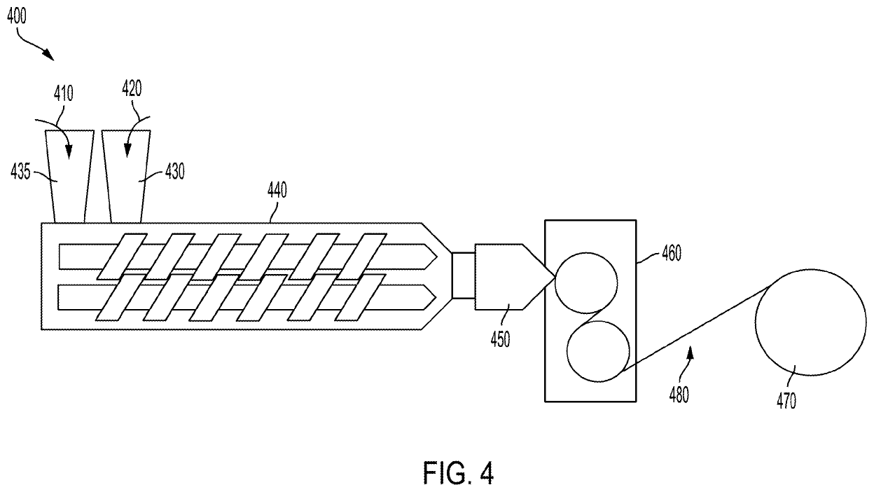

FIG. 4 illustrates another example system for producing a film according to some embodiments of the invention. The system 400 is a one-step process for producing a film using a twin-screw extruder 440. In some embodiments, the twin-screw extruder 440 can be a co-rotating, twin-screw extruder. Particularly suitable co-rotating, twin-screw extruder includes, for example, a ZSK-30 extruder available from Werner & Pfleiderer Corporation of Ramsey, N.J., or a Thermo Prism™ USALAB 16 extruder available from Thermo Electron Corp., Stone, England. The water-soluble polymer 410 and TPU 420 can be provided to the extruder 440 via the hopper 430. The water-soluble polymer 410 and TPU 420 can be fed to the extruder 440 at a pre-set drop rate. The polymer blend can be co-extruded into a film 480 at an extrusion temperature ranging from 50° C. to 300° C., e.g., from 75° C. to 250° C., from 100° C. to 225° C., from 120° C. to 215° C. or from 120° C. to 200° C. In some embodiments, the extruder 440 can be operated at a set screw speed ranging from 110 rpm to 280 rpm, e.g., from 120 rpm to 270 rpm, from 130 rpm to 250 rpm, from 140 rpm to 225 rpm, from 150 rpm to 210 rpm, or from 150 rpm to 200 rpm. The film from the extruder can be processed through the film die 450 and chill roller 460 to produce the final film 480, which is drawn through the system and/or taken up on the winder 470.

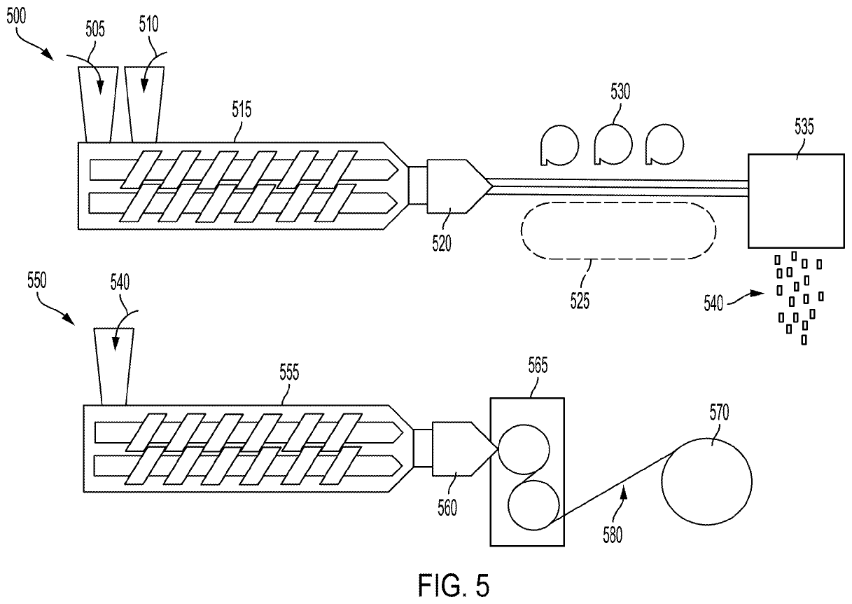

FIG. 5 illustrates another example system for producing a film according to some embodiments of the invention. FIG. 5 illustrates a two-step process for producing a film, including pelletizing system 500 and film-forming system 550. In this embodiment, the polymer components are compounded into pellets 540 in pelletizing system 500 and then the pellets 540 are extruded in film-forming system 550 to produce the film 580. In pelletizing system 500, the water-soluble polymer 505 and TPU 510 can be metered or flood fed into a twin-screw extruder 515 at a specific ratio.

In some embodiments, the polymer blend can be melt blended via the twin-screw extruder 515 at an extrusion temperature to form a homogeneous polymer blend. The molten polymer blend can then be extruded through a filament die 520. Thereafter, the extruded material may be chilled and cut into pellet form. In some embodiments, the extruded material can be air-cooled on a conveyor 525 using fans 530, and cut into pellets using a pelletizing system 535.

The pellets 540 can then be processed in film-forming system 550 in a second step to produce the film. The compounded pellets 540 can be flood fed into a single-screw or twin-screw extruder 555 with a cast film die 560. The pellets are melted in the extruder 555 at an extrusion temperature and extruded through the film die 560 onto chill rollers 565. The film 580 can then be wound into roll via winder 570. If a multilayered film is to be produced, the multiple layers are co-extruded together onto a casting roll. The casting roll may optionally be provided with embossing elements to impart a pattern to the film.

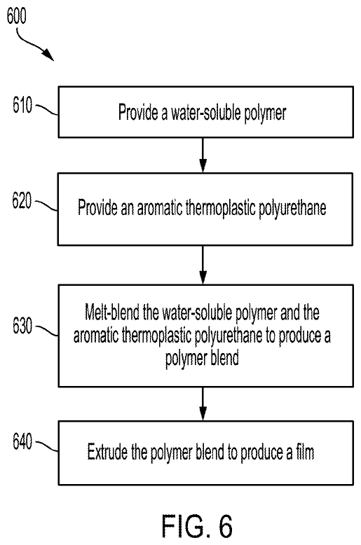

FIG. 6 provides a flow diagram of a method for producing a film according to some embodiments. In some embodiments, a method 600 of producing a film is provided. The method 600 may include providing a water-soluble polymer 610. As described herein, the water-soluble polymer may be substantially crystalline For example, the water-soluble polymer may have a crystallinity of greater than 50%, e.g., greater than 55%, greater than 60%, greater than 65%, greater than 70%, greater than 75%, greater than 80%, greater than 85%, or greater than 90%. In some embodiments, the water-soluble polymer may comprise polyethylene oxide, hydroxypropyl cellulose, polyvinyl alcohol, polyvinyl pyrrolidone, polyvinyl pyridine, gelatinized starch, nylon copolymers, polyacrylic acid, and mixtures thereof.

The method 600 may include providing an aromatic TPU 620. As described herein, the aromatic TPU contributes to the expansion properties of the film when in contact with water. The aromatic TPU can be provided in the form of a pellet or powder. In some embodiments, the aromatic TPU can have a tensile strength ranging from 10 MPa to 50 MPa. In some embodiments, the aromatic TPU can have a tensile modulus ranging from 15 MPa to 30 MPa.

The method 600 may include melt blending the water-soluble polymer and the aromatic TPU 630 to produce a polymer melt. In some embodiments, the water-soluble polymer and the aromatic TPU can be melt blended in an extruder. For example, the water-soluble polymer, the aromatic TPU, and other additives can be melt blended in single-screw extruder or a twin-screw extruder. In some embodiments, the water-soluble polymer and the aromatic TPU may first be dry mixed together to form an essentially homogeneous mixture, and they may likewise be supplied either simultaneously or in sequence to a melt processing device (e.g., extruder) that uniformly blends the materials. The water-soluble polymer and the aromatic TPU are melt blended such that the aromatic TPU is well distributed within the water-soluble polymer matrix for uniform expansion of the film, i.e., an equal percentage of expansion in the machine direction (MD) and the cross direction (CD) of the film. In some embodiments, the method may include providing additional additives to the polymer blend (e.g., plasticizers, surfactants, superabsorbent polymers, etc.).

The method 600 may include extruding the composition to produce a film 640. In some embodiments, the film comprises the water-soluble polymer in an amount from 30 wt. % to 70 wt. %, based on the total weight of the film and the aromatic TPU in an amount from 30 wt. % to 70 wt. %, based on the total weight of the film. The weight ratio of the water-soluble polymer to the aromatic TPU in the composition can range from 1:1 to 4:1. In some embodiments, the method may include cutting a pattern into the expandable film. For example, the pattern may be stamped or cut into the film to produce apertures that can serve as a water-responsive valve. The pattern be any of the valve designs discussed herein, such as, for example in FIG. 2.

### Examples

Sample films were tested to determine the expansion properties of the films described herein. Comparative Examples 1˜4 and Examples 1-16 were prepared according to the methods described below. Examples 1-16 included an aromatic TPU and Comparative Examples 1-3 included an aliphatic TPU. Comparative Example 4 include a water-soluble polymer having low crystallinity (e.g., less than 50%). Table 3 provides the film composition for each of Comparative Examples 1˜4 and Examples 1-16.

TABLE 3

| | | | | Water-soluble Polymer | | |
|---|---|---|---|---|---|---|
| | Thermoplastic Polyurethane | | | | | Crystal- |
| | | | Wt. | | Wt. | linity |
| | Name | Aromatic | % | Name | % | (%) |
| Ex. 1 | TPU-1 | Yes | 40 | PEO-1 | 60 | |
| Ex. 2 | TPU-2 | Yes | 40 | PEO-1 | 60 | 47.8 |
| Ex. 3 | TPU-3 | Yes | 40 | PEO-1 | 60 | |
| Ex. 4 | TPU-4 | Yes | 40 | PEO-1 | 60 | |
| Ex. 5 | TPU-5 | Yes | 40 | PEO-1 | 60 | |
| Ex. 6 | TPU-6 | Yes | 40 | PEO-1 | 60 | |
| Ex. 7 | TPU-7 | Yes | 40 | PEO-1 | 60 | |
| Ex. 8 | TPU-2 | Yes | 30 | PEO-1 | 70 | 56 |
| Ex. 9 | TPU-2 | Yes | 20 | PEO-1 | 80 | 61 |
| Ex. 10 | TPU-2 | Yes | 47 | PEO-1 | 53 | |
| Ex. 11 | TPU-2 | Yes | 40 | PEO-2 | 60 | |
| Ex. 12 | TPU-2 | Yes | 30 | PEO-2 | 70 | |
| Ex. 13 | TPU-5 | Yes | 40 | PEO-1 | 60 | |
| Ex. 14 | TPU-5 | Yes | 40 | PEO-1 | 60 | |
| Ex. 15 | TPU-5 | Yes | 40 | PEO-1 | 60 | |
| Ex. 16 | TPU-5 | Yes | 40 | PEO-1 | 60 | |
| Comp. 1 | TPU-8 | No | 40 | PEO-1 | 60 | |
| Comp. 2 | TPU-9 | No | 40 | PEO-1 | 60 | |
| Comp. 3 | TPU-10 | No | 40 | PEO-1 | 60 | |
| Comp. 4 | TPU-2 | Yes | 40 | PVOH-1 | 60 | 12.6 |

The crystallinity measurements of a few of the samples were measured. The crystallinity was measured by differential scanning calorimetry (DSC) using DSC Q 200 from TA Instruments in a nitrogen atmosphere for a sample mass range from 4.9 mg to 5.8 mg. The method log for DSC was the following:
1. Room temperature to 0° C. @ 10.00° C./min, isothermal for 2.0 min;
2. 0 to 125° C. @ 10.0° C./min, isothermal for 2.0 min;
3. 125 to −50° C. @ 10.0° C./min, isothermal for 2.0 min; and
4. −50 to 125° C. @ 10.0° C./min, isothermal for 2.0 min.
   The degree of crystallinity (⋅_{c}) can be measured according to the following formula (I):

$${χ}_{c} = \frac{Δ {H}_{m}}{Δ {H}_{m}^{0}} \times 100 \% , \qquad ( I )$$

where ΔHₘ is the enthalpy of melting, and

$$Δ {H}_{m}^{0}$$

the enthalpy of melting of 100% pure PEO is 196 J/g. The degree of crystallinity χ_{c} was calculated from the 2^{nd} heating cycle.

Examples 1, 3, and 4 were prepared by the process shown in FIG. 3. The water-soluble polymer (in powder form) and TPU (in pellet form) were flood fed into a HAAKE™ Rheomex OS Single Screw Extruder (Thermo Fisher Scientific, 25:1 length to diameter ratio). The HAAKE™ Rheomex OS Single Screw Extruder had a 0.75-inch screw diameter. The polymers were melt blended in the extruder at an extrusion temperature to form a homogeneous polymer blend. A HAAKE™ melt pump attached to the extruder fed the homogeneous polymer blend to a HAAKE™ 6-inch film die to produce the film. The film was collected on a HAAKE™ film take-up system including a chiller.

Examples 5, 6, 10, and 13-16 and Comparative Example 2 were prepared by the process shown in FIG. 4. The water-soluble polymer (in powder form) and TPU (in pellet form) were fed to a ZSK-30 Twin-Screw Extruder (available from Werner & Pfleiderer Corporation of Ramsey, N.J., length up to 1328 mm and diameter of 30 mm) at a pre-set drop rate. The ZSK-30 Twin-Screw Extruder had 14 barrels. The polymers were melt blended in the extruder at a temperature from 120° C. to 200° C. to form a homogeneous polymer blend and die-cast to produce the film. The screw speed of the extruder was from 150 rpm to 200 rpm.

Examples 2, 7, 8, 9, 11, and 12, and Comparatives Examples 1, 3 and 4 were prepared by the process shown in FIG. 5. The water-soluble polymer (in powder form) and TPU (in pellet form) were fed to a ZSK-30 Twin-Screw Extruder (available from Werner & Pfleiderer Corporation of Ramsey, N.J., length up to 1328 mm and diameter of 30 mm). The water-soluble polymer and TPU were separately metered into the extruder at a specific ratio to produce thick filaments. Thick filaments were extruded onto an air-cooling conveyer including fans. At the end of the conveyer, the filaments were collected on a tray to air-cool from 30 minutes to 1 hour. After cooling, the filaments were pelletized into small pellets. The pre-compounded pellets were fed into a co-rotating twin-screw extruder to cast the film. The film was extruded onto a chill roll and ultimately wound on a roll.

Table 4 provides the results of immersion tests of each of Examples 1-16 and Comparative Examples 1-4. The films were evaluated to determine expansion performance using an immersion test in aqueous solution. Strips of 80 mm (MD)×20 mm (CD) films were cut from the base sheet film along the MD at the fixed position in the cross direction of the film. The strips were weighed, and the initial thicknesses were recorded. Then, the strips were immersed in a 0.9 wt. % NaCl saline solution bath. After one minute, the dimensions of the films were recorded, and then after 15 minutes, the dimensions were recorded again. The water-responsive films may be dynamic when immersed in the aqueous solution as they might curl and twist. Therefore, tweezers were used to straighten out the film for accurate dimensional measurements at the one-minute interval with the aid of a ruler which was submerged in the bath. After 15 minutes, the films were removed from the saline and allowed to air dry. Once dry, the final mass was recorded. The testing was conducted with three replicate films of each blend.

TABLE 4

| | | Δ | Δ | Δ | Δ | Δ | Δ | | |
|---|---|---|---|---|---|---|---|---|---|
| | | Length | Width | Area | Length | Width | Area | Initial | Mass |
| | | after 1 | after 1 | after 1 | after 15 | after 15 | after 15 | Thickness | Loss |
| | Aromatic | min. (%) | min. (%) | min. (%) | min. (%) | min. (%) | min. (%) | (μm) | (%) |
| Ex. 1 | Yes | 26 | 30 | 64 | 9 | 17 | 27 | 124 | 16 |
| Ex. 2 | Yes | 47.5 | 37.5 | 103 | 21.3 | 15 | 40 | 108 | 35 |
| Ex. 3 | Yes | 41.7 | 50 | 113 | — | — | — | 98 | 19.4 |
| Ex. 4 | Yes | 42.8 | 50 | 114 | — | — | — | 92 | 23.2 |
| Ex. 5 | Yes | 53.3 | 33.3 | 105 | 15.8 | 8.9 | 26 | 112 | 37 |
| Ex. 6 | Yes | 33.3 | 0 | 33 | — | — | — | 72 | — |
| Ex. 7 | Yes | 6.6 | 25 | 33 | — | — | — | 78 | 16 |
| Ex. 8 | Yes | 50 | 47.5 | 121 | 16.9 | 20 | 40 | 79 | 50.6 |
| Ex. 9 | Yes | 37.5 | 25 | 72 | 0 | 0 | 0 | 98 | 66.2 |
| Ex. 10 | Yes | 47 | 30 | 91 | — | — | — | 139 | 23 |
| Ex. 11 | Yes | 23.8 | 28.3 | 59 | 3.3 | 6.7 | 10 | 77 | 45.7 |
| Ex. 12 | Yes | 37.9 | 38.3 | 91 | 7.5 | 3.3 | 11 | 100 | 54.5 |
| Ex. 13 | Yes | 42.1 | 18.3 | 69 | 25.4 | 11.7 | 40 | 45 | |
| Ex. 14 | Yes | 68.3 | 26.7 | 113 | 28.3 | 6.7 | 36 | 90 | 46.7 |
| Ex. 15 | Yes | 32.5 | 48.3 | 97 | −0.4 | 6.7 | 6.2 | 118 | 33.0 |
| Ex. 16 | Yes | 41.3 | 50.0 | 112 | 19.2 | 26.7 | 50.9 | 145 | 42.1 |
| Comp. 1 | No | −7.1 | −11.2 | −18 | — | — | — | 88 | — |
| Comp. 2 | No | −1 | −19 | −20 | −14 | — | — | — | — |
| Comp. 3 | No | −9.6 | −5 | −14.1 | — | — | — | 92 | — |
| Comp. 4 | Yes | 0 | 0 | 0 | — | — | — | 43 | 4 |

The data from the immersion tests in Table 4 indicates that all of the films of Examples 1-16 comprising aromatic TPU expanded in two dimensions (length and width) after immersion in water for 1 minute, with the exception of Example 6. The expansion is demonstrated regardless of whether the film was prepared using the different processes described above (e.g., single screw extruder, twin screw extruder, or two-step process). For example, films that were measured after 15-minutes immersion, the data shows that the film dimensions were returning toward their original dimensions. Specifically, the length and width of the films of Examples 1, 2, 5, 8, 9, and 11-16 all decreased toward their original dimensions. Comparative Examples 1-3, which each included an aliphatic TPU, shrank in two dimensions (length and width) after immersion in water for 1 minute, regardless of whether the films were prepared with a one-step process or a two-step process.

Comparative Example 4 included 60 wt. % polyvinyl alcohol as the water-soluble polymer and 40 wt. % TPU. The crystallinity of the polyvinyl alcohol was 16.2% according to DSC analysis. Comparative Example 4 and Example 2 included the same amount of water-soluble polymer and aromatic TPU and were made according to the same process. The data in Table 3 demonstrates that the Comparative Example 4, containing polyvinyl alcohol did not expand, despite containing the same aromatic TPU as Example 2. The crystallinity of the water-soluble polymer (polyvinyl alcohol) was significantly lower than that of the water-soluble polymer (polyethylene oxide) used in Examples 1-7 (16% versus 77%), which may contribute to the film of Comparative Example 4 lacking any water-responsive expansion properties.

Examples 2, 8, 9 and 10 are films including different percentages of PEO-1 (water-soluble polymer) and TPU-2. Example 2 included 60 wt. % water-soluble polymer, Example 8 included 70 wt. % water-soluble polymer, Example 9 included 80 wt. % water-soluble polymer, and Example 10 included 53 wt. % water-soluble polymer. The films of Examples 8 and 9 were made according to a different process than Example 10. The data demonstrates that the films of Examples 2, 8, 9, and 10 each expand well after a 1-minute immersion in water in both the length and width dimensions. Example 9, which included the least amount of TPU (20 wt. %) showed the least amount of expansion in length and width compared to Examples 8 and 10.

Examples 11 and 12 are films including 60 wt. % and 70 wt. % PEO-2 (water-soluble polymer) and 40 wt. % and 30 wt. % TPU-2, respectively. Examples 11 and 12 were both produced according to the same process. In these examples, the polyethylene oxide water-soluble polymer had a molecular weight of 100,000 g/mol and a crystallinity measured to be about 71.7%, whereas PEO-1 has a molecular weight of 200,000 g/mol and a crystallinity of 77%. Although the water-soluble polymer of Examples 11 and 12 had a lower molecular weight, it had sufficient crystallinity to support water-responsive film expansion upon immersion.

Examples 13, 14, 15, and 16 are films including 60 wt. % PEO-1 (water-soluble polymer) and 40 wt. % TPU-5. The films of Examples 13 and 14 were prepared by the process described above (one-step process with a single-screw extruder) and Examples 15 and 16 were prepared according to a different process (two-step process with a twin-screw extruder). Example films of different weights were tested for water-responsive behavior using the aqueous immersion test.

The results show that each of the films of Examples 13-14 expanded in both length and width after 1-minute of immersion. Although the area of expansion after 1-minute of immersion does not seem to be sensitive to the method of production, there appears to be greater expansion in the two dimensions for films produced by two-step process including compounding and extrusion (FIG. 5). This is likely due to better dispersion of the TPU within the dominant water-soluble polymer phase in these runs. Thus how to uniformly disperse TPU into water-soluble polymer or verves verso is one of the key factors to make expandable film here.

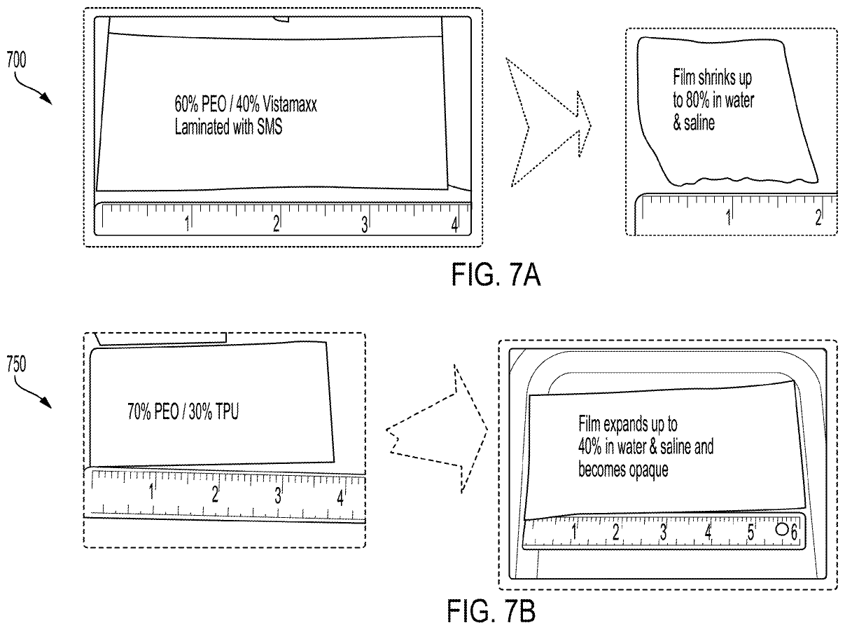

FIGS. 7A and 7B illustrate the different responses to water for a conventional film (FIG. 7A) and the films described herein (FIG. 7B). Specifically, FIG. 7A shows a schematic illustration 700 of the response to water/saline for a comparative film comprising 60 wt. % polyethylene oxide (a water-soluble polymer) and 40 wt. % VISTAMAXX (polypropylene copolymer), obtained from ExxonMobil Chemical Corporation. The film was laminated to a spunbond-meltblown-spunbond (SMS) nonwoven. FIG. 7B shows a schematic illustration 750 of the response to water/saline for an example film comprising 70 wt. % polyethylene oxide (a water-soluble polymer) and 30 wt. % aromatic TPU. The film was laminated to a SMS nonwoven. As shown in FIG. 7B, the film including the polyethylene oxide (which is a substantially crystalline water-soluble polymer) and aromatic TPU expands when in contact with water. Specifically, when the example film is immersed in water, it expands from its original length of about 4 inches to a length of about 6 inches. Although the measurement is not shown, it is clear from visual inspection that the width of the film has grown as well in FIG. 7B. On the other hand, as shown in FIG. 7A, the comparative film shrank up to 80% after contact with water.

All patents, publications and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto and the following embodiments:

Embodiment 1: A water-responsive film comprising a water-soluble polymer and an aromatic thermoplastic polyurethane (TPU), wherein the film has a degree of crystallinity of at least 25%.

Embodiment 2: The water-responsive film of any preceding or subsequent embodiment, wherein the water-soluble polymer comprises polyethylene oxide, hydroxypropyl cellulose, polyvinyl alcohol, polyvinyl pyrrolidone, polyvinyl pyridine, gelatinized starch, nylon copolymers, polyacrylic acid, or combinations thereof.

Embodiment 3: The water-responsive film of any preceding or subsequent embodiment, wherein the water-soluble polymer comprises polyethylene oxide.

Embodiment 4: The water-responsive film of any preceding or subsequent embodiment, wherein the polyethylene oxide comprises a molecular weight ranging from 50,000 g/mol to 500,000 g/mol.

Embodiment 5: The water-responsive film of any preceding or subsequent embodiment, wherein the aromatic TPU comprises a polyester-based TPU.

Embodiment 6: The water-responsive film of any preceding or subsequent embodiment, wherein the film has a degree of crystallinity from 25% to 60%.

Embodiment 7: The water-responsive film of any preceding or subsequent embodiment, wherein the film comprises the water-soluble polymer in an amount from 10 wt. % to 90 wt. %, based on the total weight of the film.

Embodiment 8: The water-responsive film of any preceding or subsequent embodiment, wherein the film comprises the aromatic TPU in an amount from 10 wt. % to 90 wt. %, based on the total weight of the film.

Embodiment 9: The water-responsive film of any preceding or subsequent embodiment, wherein a weight ratio of water-soluble polymer to the aromatic TPU is at least 1:1.

Embodiment 10: The water-responsive film of any preceding or subsequent embodiment, wherein the film comprises the water-soluble polymer in an amount from 30 wt. % to 70 wt. %, based on the total weight of the film, TPU in an amount from 30 wt. % to 70 wt. %, based on the total weight of the film, and a ratio of water-soluble polymer to aromatic TPU is at least 1.5:1.

Embodiment 11: The water-responsive film of any preceding or subsequent embodiment, wherein the film comprises one or more additives comprising surfactants, absorbents, antibiotics, or skin benefit agents.

Embodiment 12: The water-responsive film of any preceding or subsequent embodiment, wherein the additive comprises a superabsorbent.

Embodiment 13: The water-responsive film of any preceding or subsequent embodiment, wherein the film is cut or scored to include one or more apertures.

Embodiment 14: The water-responsive film of any preceding or subsequent embodiment, wherein the film comprises a tensile strength from 10 to 50 MPa and a tensile modulus of from 1 to 5 MPa.

Embodiment 15: A water-responsive film comprising: 30 wt. % to 70 wt. % of a water-soluble polymer, based on the total weight of the film, wherein the water-soluble polymer has a degree of crystallinity greater than 50%; 30 wt. % to 60 wt. % of an aromatic thermoplastic polyurethane, based on the total weight of the film; wherein the film has a degree of crystallinity from 25% to 60%.

Embodiment 16: A method of producing a water-responsive expandable film, the method comprising: melt blending a composition comprising a water-soluble polymer and an aromatic TPU; and extruding the composition to produce a film.

Embodiment 17: The method of any preceding or subsequent embodiment, wherein the film comprises the water-soluble polymer in an amount from 30 wt. % to 70 wt. %, based on the total weight of the film, and the film comprises the aromatic TPU in an amount from 30 wt. % to 60 wt. %, based on the total weight of the film.

Embodiment 18: The method of any preceding or subsequent embodiment, wherein a ratio of the water-soluble polymer to the aromatic TPU in the composition is from 1:1 to 4:1.

Embodiment 19: The method of any preceding or subsequent embodiment, wherein the water-soluble polymer comprises polyethylene oxide, hydroxypropyl cellulose, polyvinyl alcohol, polyvinyl pyrrolidone, polyvinyl pyridine, gelatinized starch, nylon copolymers, polyacrylic acid, or combinations thereof, and the aromatic TPU comprises a polyester-based TPU.

Embodiment 20: The method of any preceding or subsequent embodiment, wherein the method further comprises cutting a pattern into the expandable film.

Embodiment 21: The method of any preceding or subsequent embodiment, wherein the method further comprises bonding the film to a base layer.

What is claimed is:

1. A water-responsive film comprising:
a water-soluble polymer; and
an aromatic thermoplastic polyurethane (TPU);
wherein the film has a degree of crystallinity of at least 25%.

2. The water-responsive film of claim 1, wherein the water-soluble polymer comprises polyethylene oxide, hydroxypropyl cellulose, polyvinyl alcohol, polyvinyl pyrrolidone, polyvinyl pyridine, gelatinized starch, nylon copolymers, polyacrylic acid, or combinations thereof.

3. The water-responsive film of claim 1, wherein the water-soluble polymer comprises polyethylene oxide.

4. The water-responsive film of claim 3, wherein the polyethylene oxide comprises a molecular weight ranging from 50,000 g/mol to 500,000 g/mol.

5. The water-responsive film of claim 1, wherein the aromatic TPU comprises a polyester-based TPU.

6. The water-responsive film of claim 1, wherein the film has a degree of crystallinity from 25% to 60%.

7. The water-responsive film of claim 1, wherein the film comprises the water-soluble polymer in an amount from 10 wt. % to 90 wt. %, based on the total weight of the film.

8. The water-responsive film of claim 1, wherein the film comprises the aromatic TPU in an amount from 10 wt. % to 90 wt. %, based on the total weight of the film.

9. The water-responsive film of claim 1, wherein a weight ratio of water-soluble polymer to the aromatic TPU is at least 1:1.

10. The water-responsive film of claim 1, wherein the film comprises the water-soluble polymer in an amount from 30 wt. % to 70 wt. %, based on the total weight of the film, TPU in an amount from 30 wt. % to 60 wt. %, based on the total weight of the film, and a ratio of water-soluble polymer to aromatic TPU is at least 1.5:1.

11. The water-responsive film of claim 1, wherein the film comprises one or more additives comprising surfactants, absorbents, antibiotics, or skin benefit agents.

12. The water-responsive film of claim 11, wherein the one or more additives comprises a superabsorbent.

13. The water-responsive film of claim 1, wherein the film is cut or scored to include one or more apertures.

14. The water-responsive film of claim 1, wherein the film comprises a tensile strength from 10 to 50 MPa and a tensile modulus of from 1 to 5 MPa.

15. A water-responsive film comprising:
30 wt. % to 70 wt. % of a water-soluble polymer, based on the total weight of the film, wherein the water-soluble polymer has a degree of crystallinity greater than 50%; and
30 wt. % to 60 wt. % of an aromatic thermoplastic polyurethane, based on the total weight of the film;
wherein the film has a degree of crystallinity from 25% to 60%.

16. A method of producing a water-responsive expandable film, the method comprising:
melt blending a composition comprising a water-soluble polymer and an aromatic TPU; and
extruding the composition to produce a film.

17. The method of claim 16, wherein the film comprises the water-soluble polymer in an amount from 30 wt. % to 70 wt. %, based on the total weight of the film;
wherein the film comprises the aromatic TPU in an amount from 30 wt. % to 60 wt. %, based on the total weight of the film; and
wherein a ratio of the water-soluble polymer to the aromatic TPU in the composition is from 1:1 to 4:1.

18. The method of claim 16, wherein the water-soluble polymer comprises polyethylene oxide, hydroxypropyl cellulose, polyvinyl alcohol, polyvinyl pyrrolidone, polyvinyl pyridine, gelatinized starch, nylon copolymers, polyacrylic acid, or combinations thereof; and
wherein the aromatic TPU comprises a polyester-based TPU.

19. The method of claim 16, further comprising cutting a pattern into the film.

20. The method of claim 19, further comprising bonding the film to a base layer.
